(19) United States
(12) Patent Application Publication
(10) Pub. No.: US 2012/0088700 A1
(43) Pub. Date: Apr. 12, 2012

(54) Inhibiting Carbon Dioxide Induced Deposition

(75) Inventor: Paul R. Hart, Sugar Land, TX (US)

(73) Assignee: CHAMPION TECHNOLOGIES, INC., Houston, TX (US)

(21) Appl. No.: 13/271,854

(22) Filed: Oct. 12, 2011

Related U.S. Application Data
(60) Provisional application No. 61/392,145, filed on Oct. 12, 2010.

(51) Int. Cl. C09K 8/524

(52) U.S. Cl. 507/205; 507/200; 507/203; 507/267; 507/244; 507/268; 507/243; 507/266; 507/261; 507/239; 507/263; 507/249; 507/245; 507/256

(57) ABSTRACT

An asphaltene and resin precipitation inhibiting solution formed of an asphaltene and resin precipitation inhibiting compound and a solvent miscible in a carbon dioxide liquid or supercritical fluid. The inhibiting compound includes a head region with an affinity for asphaltene and resin components of a hydrocarbon mixture that is greater than its affinity for water, carbon dioxide, and aliphatic components of the hydrocarbon mixture. The head region includes one or more unsaturated hydrocarbon groups or one or more nonionic dipolar groups. The inhibiting compound also includes a tail region with an affinity for carbon dioxide that is greater than its affinity for substantially all components of the hydrocarbon mixture and water. The tail region includes one or more nonionic quadrupolar groups. An effective amount of solution is added to a hydrocarbon mixture in an underground reservoir when employing a carbon dioxide fluid to flush the hydrocarbon mixture from the reservoir.

### CROSS-REFERENCE TO RELATED APPLICATIONS

This application claims priority to co-pending U.S. provisional patent application Ser. No. 61/392,145, filed on Oct. 12, 2011.

### BACKGROUND OF THE INVENTION

1. Field of the Invention

The present invention relates to the production of hydrocarbons from subterranean formations. More particularly, the present invention relates to inhibiting precipitation of asphaltenes and resins from the hydrocarbons when employing a carbon dioxide fluid to enhance production of the hydrocarbons.

2. Background of the Related Art

Asphaltenes in crude oil are usually associated into micelles, which are kept in colloidal suspension in the crude oil by resins. These resin molecules are surfactants with heads that are sufficiently polar to adsorb onto the asphaltene micelles but tails aliphatic enough to keep the asphaltene micelles apart and colloidally dispersed in the largely aliphatic crude oil.

Changes in temperature, pressure, or fluid composition desorb these resins from the micelles and precipitate the asphaltenes from the oil. Changes in concentration of alkane components dissolve the adsorbed layer of resin molecules that keep the asphaltenes colloidally dispersed in crude oil. Conventional synthetic precipitate inhibitors or dispersants may be added to replace this layer of resins with synthetic chemicals having a similar, but more adsorptive, molecular structure, namely, various polar, asphaltene-seeking groups connected to tails having aliphatic hydrocarbon groups compatible with the alkane precipitant. Conventional synthetic precipitate inhibitors can be added to replace the desorbed resins immediately or at a later stage of aggregation short of deposition.

Examples of these conventional precipitate inhibitors include products in Baker Petrolite's PAO line, Champion Technologies' Flotron line, and Halliburton's TarChek line. Raw materials sold for the purpose of making these products include alkylarylsulfonic acids and their salts, polyisobutylene succinic acids, their esters and amides, and alkylphenol-formaldehyde resins, fatty acid condensates or fatty epoxide adducts with amines and polyamines or alcohols and polyols, fatty alcohol or fatty amine condensates with carboxylic acids or polycarboxylic acids (polyacrylics or maleics). Providers of these materials include AkzoNobel, Lubrizol, Marchem, SI Group, and Aquaness.

Carbon dioxide is often used to increase the production of petroleum from underground reservoirs. As a dense supercritical fluid, carbon dioxide dissolves in the oil in the underground reservoir to reduce its viscosity and carries the oil out of the reservoir. The presence of carbon dioxide, however, induces the precipitation and deposition of asphaltene and resin components of the crude oil. Carbon dioxide causes deposits not because it desorbs the resins from the asphaltenes, but because it renders the resins non-dispersive of the asphaltenes.

Currently, the conventional synthetic precipitate materials that inhibit the deposition of asphaltenes from saturated hydrocarbons (e.g., methane, pentane, and heptane) are added to inhibit the carbon-dioxide induced deposits. These chemicals, however, have only a limited effect on deposits induced by carbon dioxide because they do not disperse the precipitate in carbon dioxide.

### BRIEF SUMMARY OF THE INVENTION

One embodiment of the present invention includes an asphaltene and resin precipitation inhibiting compound including a head region and a tail region. The head region may have an affinity for asphaltene and resin components of a hydrocarbon mixture that is greater than its affinity for water, its affinity for carbon dioxide, and its affinity for aliphatic components of the hydrocarbon mixture. The tail region may have an affinity for carbon dioxide that is greater than its affinity for substantially all components of the hydrocarbon mixture and its affinity for water.

The head region may include one or more unsaturated hydrocarbon groups selected from the group consisting of alicyclic hydrocarbons, aromatic hydrocarbons, olefinic hydrocarbons, acetylenic hydrocarbons, and graphenic hydrocarbons. The head region may include between one and one hundred unsaturated hydrocarbon groups. Alternatively, the head region may include one or more nonionic dipolar groups selected from the group consisting of carbonyls, nitriles, amine oxides, sulfoxides, large alcohols, and neutral amines. The head region may include between one and one hundred nonionic dipolar groups.

The tail region may include one or more nonionic quadrupolar groups selected from the group consisting of fluorocarbons, chlorocarbons, mixed fluoro/chlorocarbons, carboxylic esters, amides, carbonates, ureas, cyanates, isocyanates, imidazolines, acetylenic alcohols, silicones, ethers, secondary amines, cyanogens, and dimethyl hydrocarbons. The tail region may include between one and one hundred nonionic quadrupolar groups.

### BRIEF DESCRIPTION OF THE DRAWINGS

FIG. 1 is a table of inhibitors for inhibiting carbon dioxide induced deposition.

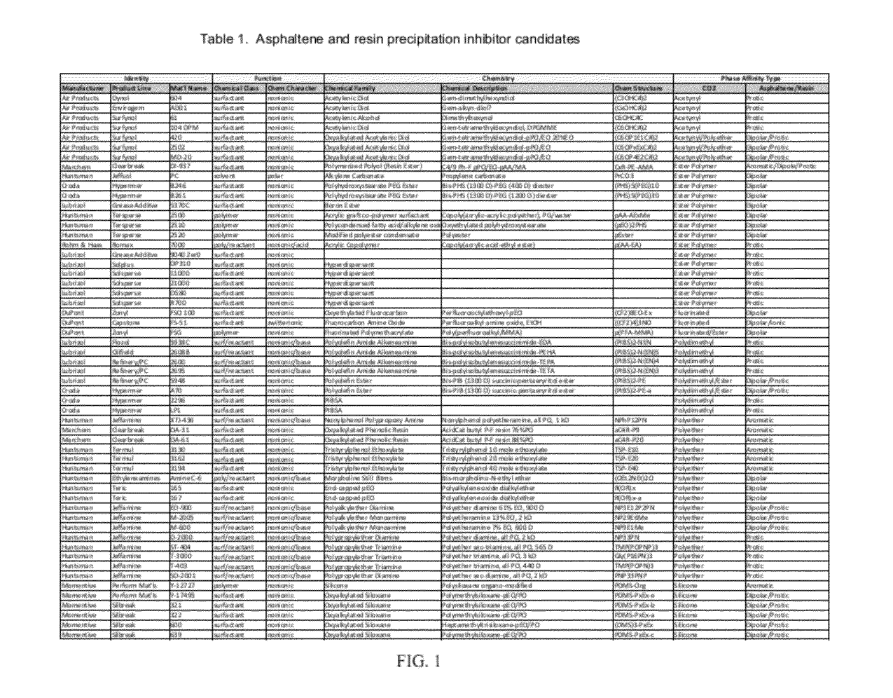

FIG. 2 is a continuation of the table in FIG. 1.

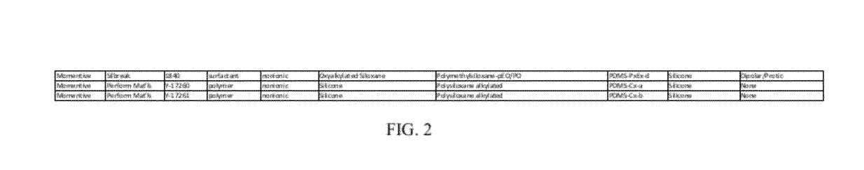

### DETAILED DESCRIPTION OF THE INVENTION

Compositions other than conventional synthetic precipitate inhibitors may be used for preventing carbon-dioxide-induced deposits because these deposits are different in origin and composition. The aliphatic-seeking tails may be replaced with carbon-dioxide-seeking tails. Less polar head groups may be used to disperse the resins along with the asphaltenes.

Inhibitors of carbon-dioxide-induced deposits of asphaltene and resin components of crude oil have a molecular structure in which dipolar or polarizable asphaltene/resin-seeking groups are connected to certain quadrupolar, carbon-dioxide-seeking groups in the substantial absence of extended hydrocarbon chains (i.e., methyl not included). Multiple quadrupoles (e.g., from about 2 to 20 quadrupole groups) are generally needed to pull the precipitate into the carbon dioxide. Representative quadrupolar groups include fluorocarbons, chlorocarbons, mixed fluro/chlorocarbons, carboxylic esters, amides, carbonates, ureas, cyanates, isocyanates, imidazolines, acetylenic alcohols, silicones, ethers, secondary amines, cyanogens, and dimethyl hydrocarbons.

Because carbon dioxide flooding is usually a secondary or tertiary recovery technique, a carbon dioxide flooded field may have already been flooded with water or brine. The ionized head groups of conventional dispersants that so efficiently adsorb onto dry asphaltene micelles adsorb preferentially at water or brine interfaces. Conventional ionic dispersants for asphaltenes in dry oil are largely wasted dispersing water instead of asphaltenes when the oil is wet.

To prevent this diversion of inhibitor in the carbon dioxide/oil/aqueous systems, the asphaltene/resin seeking head may include a larger number of more carbon dioxide phobic, nonionic head groups to achieve the same adsorption. Chemical groups that shun water and carbon dioxide relative to their affinity for polar and polycondensed organics include most unsaturated hydrocarbon groups and nonionic dipolar groups. The unsaturated hydrocarbon groups may include alcyclic, aromatic, olefinic, acetylenic, and graphenic hydrocarbon groups. The nonionic dipolar groups may include carbonyls, nitriles, amine oxides, sulfoxides, larger alcohols, and neutral amines. The smaller, neutral amines do not shun water as much, but have a greater affinity for the resin fraction (mostly long chain carboxylic acids) of the crude oil. The asphaltene/resin-seeking heads will not contain substantially ionized groups, such as salts of sulfonates, phosphonates, phenates, carboxylates, or amines, which prefer adsorption to and dispersion of produced water or brine to that of precipitated polar organics.

An asphaltene and resin precipitation inhibiting compound may include a head region and a tail region. The head region may have an affinity for asphaltene and resin components of a hydrocarbon mixture (e.g., crude oil) that is greater than its affinity for water, its affinity for carbon dioxide, and its affinity for aliphatic components of the hydrocarbon mixture. The tail region may have an affinity for carbon dioxide that is greater than its affinity for substantially all components of the hydrocarbon mixture and its affinity for water.

The head region may include one or more unsaturated hydrocarbon groups or one or more nonionic dipolar groups. The one or more unsaturated hydrocarbon groups may include alicyclic hydrocarbons, aromatic hydrocarbons, olefinic hydrocarbons, acetylenic hydrocarbons, or graphenic hydrocarbons. The nonionic dipolar groups may include carbonyls, nitriles, amine oxides, sulfoxides, large alcohols, or neutral amines. The head region may include between one and one hundred unsaturated hydrocarbon groups. In a more preferred embodiment, the head region may include between two and twenty unsaturated hydrocarbon groups. Alternatively, the head region may include between one and one hundred nonionic dipolar groups. In a more preferred embodiment, the head region may include between two and twenty nonionic dipolar groups. In another alternative, the head region may include between one and one hundred unsaturated hydrocarbon groups and nonionic dipolar groups collectively. In a more preferred embodiment, the head region may include between two and twenty unsaturated hydrocarbon groups and nonionic dipolar groups collectively.

The tail region may include one or more nonionic quadrupolar groups. The nonionic quadrupolar groups may include fluorocarbons, chlorocarbons, mixed fluoro/chlorocarbons, carboxylic esters, amides, carbonates, ureas, cyanates, isocyanates, imidazolines, acetylenic alcohols, silicones, ethers, secondary amines, cyanogens, or dimethyl hydrocarbons. The tail region may include between one and one hundred nonionic quadrupolar groups. In a more preferred embodiment, the tail region may include between two and twenty nonionic quadrupolar groups.

It is to be understood that the asphaltene and resin precipitation inhibiting compound may include all such combinations of nonionic quadrupolar tail groups connected to unsaturated hydrocarbon or nonionic dipolar head groups. Preferably, there are between two and twenty of such groups in each head and/or each tail to impart optimal adsorption and dispersion.

Examples of likely carbon-dioxide-induced deposit inhibitor candidates include acetylenic diol, acetylenic alcohol, oxyalkylated acetylenic diol, polymerized polyol, polyhydroxystearate PEG ester, boron ester, acrylic graft co-polymer surfactant, polycondensed fatty acid/alkylene oxide adduct, modified polyester condensate, acrylic copolymer, hyperdispersant, oxyethylated fluorocarbon, fluorocarbon amine oxide, fluorinated polymethacrylate, polyolefin amide alkeneamine, polyolefin ester, PIBSA, nonylphenol polypropoxy amine, oxyalkylated phenolic resin, tristyrylphenol ethoxylate, morpholine still btms, end-capped pEO, polyalkylether diamine, polyalkylether monoamine, polypropylether diamine, polypropylether triamine, silicone, and oxyalkylated siloxane. Table 1 presents examples of asphaltene and resin precipitation inhibitor candidates.

The asphaltene and resin precipitation inhibiting compounds may be dissolved in a solvent to form a liquid asphaltene and resin precipitation inhibiting solution to feed downhole. The solvent may be miscible in carbon dioxide. The solvent may be preferably miscible in supercritical carbon dioxide fluid. Carbon-dioxide-miscible solvents include cyclic ethylene, propylene carbonate, ethyl acetate, methyl formate, dimethyl formamide, acetone, acetophenone, acetonitrile, tetrahydrofuran, and many other polar aprotic solvents. Co-solvents, such as smaller alcohols (i.e., C4 or smaller) and aromatics (e.g., toluene, xylene, or aromatic naphtha), may also be added to stabilize the active components in the carbon-dioxide-miscible solvent. In another alternative, asphaltene and resin precipitation inhibiting compounds may be sufficiently liquid and miscible in carbon dioxide such that the asphaltene and resin precipitation inhibiting compounds may be used neat.

To inhibit precipitation of asphaltenes and resins from a hydrocarbon mixture (e.g., crude oil) in an underground reservoir when employing a carbon dioxide fluid to flush the hydrocarbon mixture from the underground reservoir, an effective inhibiting amount of the asphaltene and resin precipitation inhibiting solution may be added to the hydrocarbon mixture. Alternatively, the asphaltene and resin precipitation inhibiting compound may be injected with the carbon dioxide in the manner of a surfactant water flood as some asphaltene and resin precipitation inhibiting compounds may dissolve in carbon dioxide.

The asphaltene and resin precipitation inhibiting solution may be added downhole to a point upstream of where the deposition occurs by any available means (e.g., capillary string, coiled tubing, down the annulus, or squeezed into formation through the wellbore). The effective inhibiting amount may depend on the severity of the deposition and the relative effectiveness on specific fluids. The effective inhibiting amount may be between 10 ppm and 10,000 ppm of the weight of the hydrocarbon mixture (e.g., crude oil) produced (e.g., as measured at a custody transfer point). Preferably, the effective inhibiting amount may be between 10 ppm and 1000 ppm of the weight of the hydrocarbon mixture produced.

The embodiments described above are exemplary of numerous embodiments that may be made within the scope of the appended claims. It is contemplated that numerous other configurations may be used, and the material of each component may be selected from numerous materials other than those specifically disclosed. In short, it is the applicant's intention that the scope of the patent issuing herefrom will be limited only by the scope of the appended claims.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

### Specification Support for As-Yet Unclaimed Embodiments

30. A method of inhibiting precipitation of asphaltenes and resins from a hydrocarbon mixture in an underground reservoir when employing a carbon dioxide fluid to increase production of said hydrocarbon mixture from said underground reservoir, comprising: adding to said hydrocarbon mixture an effective inhibiting amount of a precipitation inhibiting solution comprising a precipitation inhibiting compound and a solvent, wherein said solvent is miscible in said carbon dioxide fluid, and wherein said precipitation inhibiting compound comprises a head region and a tail region, wherein the head region has an affinity for asphaltene and resin components of said hydrocarbon mixture that is greater than its affinity for water, its affinity for carbon dioxide, and its affinity for aliphatic components of said hydrocarbon mixture, and wherein the tail region has an affinity for carbon dioxide that is greater than its affinity for substantially all components of said hydrocarbon mixture and its affinity for water.

31. The method of claim 30, wherein said head region comprises one or more unsaturated hydrocarbon groups, and wherein said tail region comprises one or more nonionic quadrupolar groups.

32. The method of claim 31, wherein said head region comprises between one and one hundred unsaturated hydrocarbon groups.

33. The method of claim 32, wherein said head region comprises between two and twenty unsaturated hydrocarbon groups.

34. The method of claim 31, wherein said tail region comprises between one and one hundred nonionic quadrupolar groups.

35. The method of claim 34, wherein said tail region comprises between two and twenty nonionic quadrupolar groups.

36. The method of claim 31, wherein said one or more unsaturated hydrocarbon groups are selected from the group consisting of alicyclic hydrocarbons, aromatic hydrocarbons, olefinic hydrocarbons, acetylenic hydrocarbons, and graphenic hydrocarbons.

37. The method of claim 31, wherein said one or more nonionic quadrupolar groups are selected from the group consisting of fluorocarbons, chlorocarbons, mixed fluoro/chlorocarbons, carboxylic esters, amides, carbonates, ureas, cyanates, isocyanates, imidazolines, acetylenic alcohols, silicones, ethers, secondary amines, cyanogens, and dimethyl hydrocarbons.

38. The method of claim 31, wherein said solvent is a polar aprotic solvent.

39. The method of claim 38, wherein said polar aprotic solvent is selected from the group consisting of cyclic ethylene, propylene carbonate, ethyl acetate, methyl formate, dimethyl formamide, acetone, acetophenone, acetonitrile, and tetrahydrofuran.

40. The method of claim 31, wherein said effective inhibiting amount of said precipitation inhibiting solution added to said hydrocarbon mixture is between 10 ppm and 10,000 ppm of the weight of the hydrocarbon mixture produced.

41. The method of claim 40, wherein said effective inhibiting amount of said precipitation inhibiting solution added to said hydrocarbon mixture is between 100 ppm and 1,000 ppm of the weight of the hydrocarbon mixture produced.

42. The method of claim 31, wherein said precipitation inhibiting solution is added to said hydrocarbon mixture in said underground reservoir by capillary string, through coiled tubing, down an annulus of a well, or squeezed through the wellbore.

43. The method of claim 30, wherein said head region comprises one or more nonionic dipolar groups, and wherein said tail region comprises one or more nonionic quadrupolar groups.

44. The method of claim 43, wherein said head region comprises between one and one hundred nonionic dipolar groups.

45. The method of claim 44, wherein said head region comprises between two and twenty nonionic dipolar groups.

46. The method of claim 43, wherein said tail region comprises between one and one hundred nonionic quadrupolar groups.

47. The method of claim 46, wherein said tail region comprises between two and twenty nonionic quadrupolar groups.

48. The method of claim 43, wherein said one or more nonionic dipolar groups are selected from the group consisting of carbonyls, nitriles, amine oxides, sulfoxides, large alcohols, and neutral amines.

49. The method of claim 43, wherein said one or more nonionic quadrupolar groups are selected from the group consisting of fluorocarbons, chlorocarbons, mixed fluoro/chlorocarbons, carboxylic esters, amides, carbonates, ureas, cyanates, isocyanates, imidazolines, acetylenic alcohols, silicones, ethers, secondary amines, cyanogens, and dimethyl hydrocarbons.

50. The method of claim 43, wherein said solvent is a polar aprotic solvent.

51. The method of claim 50, wherein said polar aprotic solvent is selected from the group consisting of cyclic ethylene, propylene carbonate, ethyl acetate, methyl formate, dimethyl formamide, acetone, acetophenone, acetonitrile, and tetrahydrofuran.

52. The method of claim 43, wherein said effective inhibiting amount of said precipitation inhibiting solution added to said hydrocarbon mixture is between 10 ppm and 10,000 ppm of the weight of the hydrocarbon mixture produced.

53. The method of claim 52, wherein said effective inhibiting amount of said precipitation inhibiting solution added to said hydrocarbon mixture is between 100 ppm and 1,000 ppm of the weight of the hydrocarbon mixture produced.

54. The method of claim 43, wherein said precipitation inhibiting solution is added to said hydrocarbon mixture in said underground reservoir by capillary string, through coiled tubing, down an annulus of a well, or squeezed through the wellbore.

55. An asphaltene and resin precipitation inhibiting solution comprising: an asphaltene and resin precipitation inhibiting compound comprising a head region and a tail region, wherein said head region has an affinity for asphaltene and resin components of a hydrocarbon mixture that is greater than its affinity for water, its affinity for carbon dioxide, and its affinity for aliphatic components of said hydrocarbon mixture, and wherein said tail region has an affinity for carbon dioxide that is greater than its affinity for substantially all components of said hydrocarbon mixture and its affinity for water; and a solvent, wherein said solvent is miscible in a carbon dioxide fluid.

56. The asphaltene and resin precipitation inhibiting solution of claim 55, wherein said head region comprises one or more unsaturated hydrocarbon groups, and wherein said one or more unsaturated hydrocarbon groups are selected from the group consisting of alicyclic hydrocarbons, aromatic hydrocarbons, olefinic hydrocarbons, acetylenic hydrocarbons, and graphenic hydrocarbons.

57. The asphaltene and resin precipitation inhibiting solution of claim 56, wherein said head region comprises between one and one hundred unsaturated hydrocarbon groups.

58. The asphaltene and resin precipitation inhibiting solution of claim 57, wherein said head region comprises between two and twenty unsaturated hydrocarbon groups.

59. The asphaltene and resin precipitation inhibiting solution of claim 55, wherein said head region comprises one or more nonionic dipolar groups, and wherein said one or more nonionic dipolar groups are selected from the group consisting of carbonyls, nitriles, amine oxides, sulfoxides, large alcohols, and neutral amines.

60. The asphaltene and resin precipitation inhibiting solution of 59, wherein said head region comprises between one and one hundred nonionic dipolar groups.

61. The asphaltene and resin precipitation inhibiting solution of claim 60, wherein said head region comprises between two and twenty nonionic dipolar groups.

62. The asphaltene and resin precipitation inhibiting solution of claim 55, wherein said tail region comprises one or more nonionic quadrupolar groups, and wherein said one or more nonionic quadrupolar groups are selected from the group consisting of fluorocarbons, chlorocarbons, mixed fluoro/chlorocarbons, carboxylic esters, amides, carbonates, ureas, cyanates, isocyanates, imidazolines, acetylenic alcohols, silicones, ethers, secondary amines, cyanogens, and dimethyl hydrocarbons.

63. The asphaltene and resin precipitation inhibiting solution of claim 62, wherein said tail region comprises between one and one hundred nonionic quadrupolar groups.

64. The asphaltene and resin precipitation inhibiting solution of claim 63, wherein said tail region comprises between two and twenty nonionic quadrupolar groups.

65. The asphaltene and resin precipitation inhibiting solution of claim 55, wherein said solvent is a polar aprotic solvent.

66. The asphaltene and resin precipitation inhibiting solution of claim 65, wherein said polar aprotic solvent is selected from the group consisting of cyclic ethylene, propylene carbonate, ethyl acetate, methyl formate, dimethyl formamide, acetone, acetophenone, acetonitrile, and tetrahydrofuran.

67. The asphaltene and resin precipitation inhibiting solution of claim 55, wherein said solvent is miscible in a carbon dioxide liquid or in a supercritical carbon dioxide fluid.

What is claimed is:

1. A method of inhibiting precipitation of asphaltenes and resins from a hydrocarbon mixture in an underground reservoir when employing a carbon dioxide fluid to increase production of said hydrocarbon mixture from said underground reservoir, comprising:
adding to said hydrocarbon mixture an effective inhibiting amount of a precipitation inhibiting compound comprising a head region with an affinity for asphaltene and resin components of said hydrocarbon mixture that is greater than its affinity for water, its affinity for carbon dioxide, and its affinity for aliphatic components of said hydrocarbon mixture; and a tail region with an affinity for carbon dioxide that is greater than its affinity for substantially all components of said hydrocarbon mixture and its affinity for water.

2. The method of claim 1, wherein said head region comprises one or more unsaturated hydrocarbon groups, and wherein said tail region comprises one or more nonionic quadrupolar groups.

3. The method of claim 2, wherein said head region comprises between one and one hundred unsaturated hydrocarbon groups.

4. The method of claim 3, wherein said head region comprises between two and twenty unsaturated hydrocarbon groups.

5. The method of claim 2, wherein said tail region comprises between one and one hundred nonionic quadrupolar groups.

6. The method of claim 5, wherein said tail region comprises between two and twenty nonionic quadrupolar groups.

7. The method of claim 2, wherein said one or more unsaturated hydrocarbon groups are selected from the group consisting of alicyclic hydrocarbons, aromatic hydrocarbons, olefinic hydrocarbons, acetylenic hydrocarbons, and graphenic hydrocarbons.

8. The method of claim 2, wherein said one or more nonionic quadrupolar groups are selected from the group consisting of fluorocarbons, chlorocarbons, mixed fluoro/chlorocarbons, carboxylic esters, amides, carbonates, ureas, cyanates, isocyanates, imidazolines, acetylenic alcohols, silicones, ethers, secondary amines, cyanogens, and dimethyl hydrocarbons.

9. The method of claim 2, wherein said effective inhibiting amount of said precipitation inhibiting compound added to said hydrocarbon mixture is between 0.1 ppm and 10,000 ppm of the weight of the hydrocarbon mixture produced.

10. The method of claim 9, wherein said effective inhibiting amount of said precipitation inhibiting compound added to said hydrocarbon mixture is between 1 ppm and 1,000 ppm of the weight of the hydrocarbon mixture produced.

11. The method of claim 2, wherein said precipitation inhibiting compound is substantially dissolved in a solvent to form a precipitation inhibiting solution that is added to said hydrocarbon mixture, wherein said solvent is miscible in said carbon dioxide fluid.

12. The method of claim 11, wherein said solvent is a polar aprotic solvent.

13. The method of claim 12, wherein said polar aprotic solvent is selected from the group consisting of cyclic ethylene, propylene carbonate, ethyl acetate, methyl formate, dimethyl formamide, acetone, acetophenone, acetonitrile, and tetrahydrofuran.

14. The method of claim 11, wherein an effective inhibiting amount of said precipitation inhibiting solution added to said hydrocarbon mixture is between 10 ppm and 10,000 ppm of the weight of the hydrocarbon mixture produced.

15. The method of claim 14, wherein said effective inhibiting amount of said precipitation inhibiting solution added to said hydrocarbon mixture is between 100 ppm and 1,000 ppm of the weight of the hydrocarbon mixture produced.

16. The method of claim 1, wherein said head region comprises one or more nonionic dipolar groups, and wherein said tail region comprises one or more nonionic quadrupolar groups.

17. The method of claim 16, wherein said head region comprises between one and one hundred nonionic dipolar groups.

18. The method of claim 17, wherein said head region comprises between two and twenty nonionic dipolar groups.

19. The method of claim 16, wherein said tail region comprises between one and one hundred nonionic quadrupolar groups.

20. The method of claim 19, wherein said tail region comprises between two and twenty nonionic quadrupolar groups.

21. The method of claim 16, wherein said one or more nonionic dipolar groups are selected from the group consisting of carbonyls, nitriles, amine oxides, sulfoxides, large alcohols, and neutral amines.

22. The method of claim 16, wherein said one or more nonionic quadrupolar groups are selected from the group consisting of fluorocarbons, chlorocarbons, mixed fluoro/chlorocarbons, carboxylic esters, amides, carbonates, ureas, cyanates, isocyanates, imidazolines, acetylenic alcohols, silicones, ethers, secondary amines, cyanogens, and dimethyl hydrocarbons.

23. The method of claim 16, wherein said effective inhibiting amount of said precipitation inhibiting compound added to said hydrocarbon mixture is between 0.1 ppm and 10,000 ppm of the weight of the hydrocarbon mixture produced.

24. The method of claim 23, wherein said effective inhibiting amount of said precipitation inhibiting compound added to said hydrocarbon mixture is between 1 ppm and 1,000 ppm of the weight of the hydrocarbon mixture produced.

25. The method of claim 16, wherein said precipitation inhibiting compound is substantially dissolved in a solvent to form a precipitation inhibiting solution that is added to said hydrocarbon mixture, wherein said solvent is miscible in said carbon dioxide fluid.

26. The method of claim 25, wherein said solvent is a polar aprotic solvent.

27. The method of claim 26, wherein said polar aprotic solvent is selected from the group consisting of cyclic ethylene, propylene carbonate, ethyl acetate, methyl formate, dimethyl formamide, acetone, acetophenone, acetonitrile, and tetrahydrofuran.

28. The method of claim 25, wherein an effective inhibiting amount of said precipitation inhibiting solution added to said hydrocarbon mixture is between 10 ppm and 10,000 ppm of the weight of the hydrocarbon mixture produced.

29. The method of claim 28, wherein said effective inhibiting amount of said precipitation inhibiting solution added to said hydrocarbon mixture is between 100 ppm and 1,000 ppm of the weight of the hydrocarbon mixture produced.
